(19) United States
(12) Patent Application Publication
(10) Pub. No.: US 2008/0192770 A1
(43) Pub. Date: Aug. 14, 2008

(54) INTERNETWORKING MULTIPLE COMMUNICATION TECHNOLOGIES

(75) Inventors: Gary Burrows, Richardson, TX (US); Pulin R. Patel, McKinney, TX (US); Rashad Mohammad Ali, Plano, TX (US); Achal R. Patel, McKinney, TX (US)

Correspondence Address: FISH & RICHARDSON P.C., P.O. BOX 1022, MINNEAPOLIS, MN, 55440-1022, US

(73) Assignee: Mavenir Systems, Inc., Richardson, TX (US)

(21) Appl. No.: 11/673,175

(22) Filed: Feb. 9, 2007

(51) Int. Cl. H04J 3/16; H04Q 7/00

(52) U.S. Cl. 370/466; 370/331

(57) ABSTRACT

The present disclosure includes a system and method for internetworking multiple communication technologies. In some embodiments, a method includes receiving services of a first communication technology in a first protocol. The first communication technology is internetworked with a second communication technology of an end user device.

### TECHNICAL FIELD

This invention relates to network communications and, more particularly, to internetworking multiple communication technologies.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a call phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

The present disclosure includes a system and method for internetworking multiple communication technologies. In some embodiments, a method includes receiving services of a first communication technology in a first protocol. The first communication technology is internetworked with a second communication technology of an end user device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a communication system in accordance with one embodiment of the present disclosure;

FIGS. 2A and 2B are diagrams illustrating signal paths in the communication system of FIG. 1 in accordance with some embodiments of the present disclosure; and

FIGS. 3A and 3B illustrate example flow charts for internetworking different communication technologies.

Like reference symbols in the various drawings indicate like elements.

### DETAILED DESCRIPTION

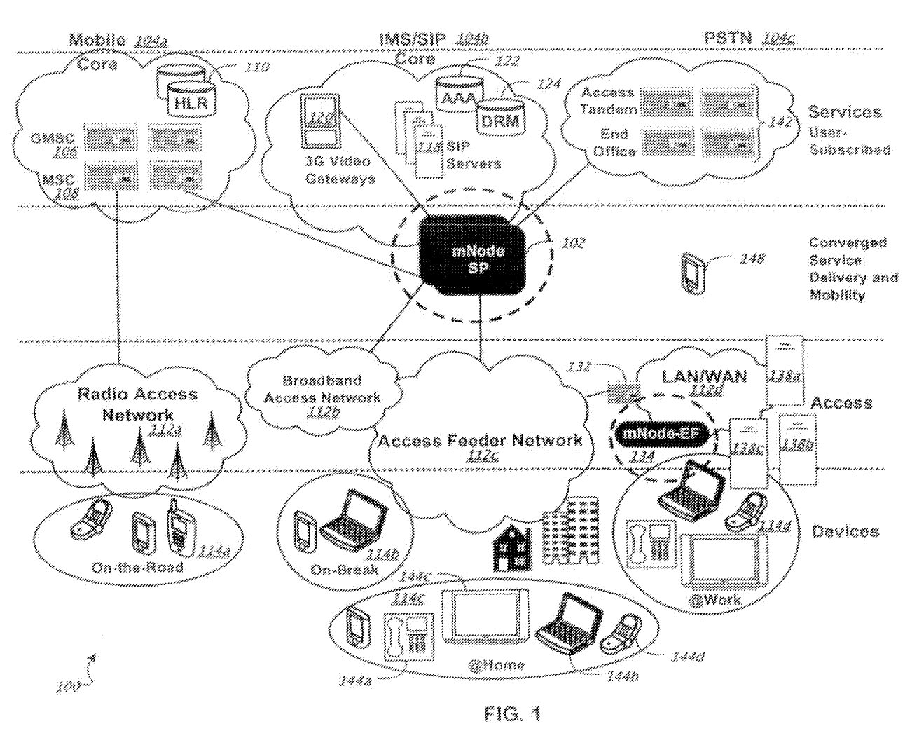

FIG. 1 illustrates a communication system 100 for internetworking a plurality of different communication technologies. The communication technologies may include Global System for Mobile Communications (GSM), General Packet Radio Service (GPRS), IP Multimedia Subsystem (IMS), digital television service (IPTV), Public Switch Telephone Network (PSTN), Universal Mobile Telecommunications System (UMTS). Code Division Multiple Access (CDMA), CDMA2000, Wide-band CDMA (WCDMA), 1X-EVDO, High Speed Downlink Packet Access (HSDPA), Peer-to-Peer (P2P) technologies (e.g., Googletalk, Skype, XMPP, Jabber), Unlicensed Mobile Access (UMA) technology, Real Time Streaming Protocol (RTSP) technologies (e.g., RealPlayer, Quicktime, Media Player), and others. For example, system 100 may modify, translate, or convert a P2P message to one of a plurality of communication technologies such as a GSM message, a SIP message, or a UMA message. In doing so, system 100 may provide P2P services to a GSM device 114, a SIP device 114, or a UMA device 114. Conventionally, network devices 114 are associated with a single core network 104 that provides services in accordance with the associated communication technologies. In internetworking a plurality of different communication technologies, devices 114 may receive services (e.g., authentication services, delivery of services, mobility of services) from a foreign core network 104 independent of the native core network 104. For example, system 100 may identify a GSM message destined for an RTSP device 114 and, in response to at least identifying the transmitting technology and the receiving technology, convert the GSM message to an RTSP message capable of being processed by the RTSP device 114. In addition, system 100 may enable communication session to be mobilized across devices 114 of disparate communication technologies. A communication session may be a call, data, video, audio, multimedia or other session in which information and requests are exchanged. In short, system 100 may provide mobility of services across terminals such as devices 114, across access networks 112, and/or across core networks 104. Such services may include Voice Service with or without Mobility Functionality (e.g., GSM UMTS, Dual Mode GSM/WiFi or BT UMA, SIP Phones, Google Talk or Skype soft phones, POTS), Presence Aware Service, and/or Multi Media Service (e.g., streaming video, IPTV via set-top box P2P Video).

At a high level, system 100 includes network element 102, core networks 104, access networks, 112, and client devices 114. Network element 102 can include any hardware, software, and/or firmware operable to convert between a plurality of different communication technologies. For example, network element 102 may receive a message from a UTMS device destined for a Google Talk soft phone. After receiving the UTMS message, network element 102 may identify the originating technology and the destination technology and, in response to at least these identifications, convert the received UMTS message to a Goggle Talk message. Network element 102 may perform any number of functions when converting between different technologies. For example, conversion functions may include one or more of the following: translating between different parameters; encapsulating at least a portion of a message; converting between real time and non-real time services; or any other suitable functions for translating between different technologies.

Network element 102 may, in one embodiment, emulate or otherwise represent itself as a client to core networks 104 and/or a server to access networks 112. For example, network element 102 may emulate a base station controller and/or an mobile switching center to mobile core 104a. In another example, network element 102 may represent itself as an call session control function (CSCF) to IMS core 104b. In yet another example, network element 102 may represent itself as an MSC to PSTN 104c. Thus, core networks 104 may query, transmit, or otherwise communicate with network element 102 like any other device associated with the core network 104. Similarly, client devices 114 may also query, receive, or otherwise communicate with network element 102 like any server in an associated core network 104. In representing both the client side and the server side, the conversion between different technologies performed by network element 102 may be transparent to both the core networks 104 an the clients 114. To facilitate these representations, network element 102 may include one or more of the following interfaces: P2P XMPP, 1v, SIP/RTP, UMA, RTSP/RTP, Internet Group Management Protocol (IGMP), or Integrated Services Digital Network User Part (ISUP).

In addition, network element 102 can include any software, hardware, and/or firmware operable to locally switch messages between devices 114. Network element 102 may be operable to receive a message from device 114 and identify a destination of the message. Network element 102 may identify a destination by realizing the address of the termination device or, for example, being provisioned to switch traffic received from a particular device, port, or session to another device, port or session. In the event that the destination of the message is a different device, network element 102 may convert the message to a different technology, if appropriate, and route the message to the receiving device. For example, network element 102 may receive a SIP message from a first device 114 and determine that the SIP message is destined for a UMA device 114. In response to at least determining that the destination is local, network element 102 may convert the SIP message to a UMA message and transmit the converted message to the appropriate UMA device 114. Similarly, in the event that network element 102 receives a UMA message from a first device 114 and determines that the receiving device is a SIP device 114, network element 102 may convert the UMA message to a SIP message and transmit the converted message to the appropriate SIP device 114.

Network element 102 may be operable to facilitate a handover between two devices, wherein a service being delivered to a first device 114 is handed-over or transitioned to a second device 114 independent of the technology standard of each device. For example, a voice call originated within a SIP device 114 may be handed-over to a GSM device 114 providing call continuity between the different technologies. In this example, both the SIP device 114 and the GSM device 114 may share a single number. In addition, network element 102 may be capable of delivering a notification of an incoming call (e.g., ring tone) to multiple devices 114 where each device 114 is based on different communication technology. For example, in the case that a Skype client 114 and a UMA handset 114 share a single number, an incoming call to that number may trigger a call received alert in both devices 114 even though that are based on different communication technologies. The hand-off feature is not limited to voice services. Any voice, video, data, or multimedia session may be capable of session hand-off. For example, a user engaged in a multimedia session on a GSM handset 114 may be able to transfer that session to an IPTV set-top box 114. In some embodiments, network element 102 may provide continuity of the multimedia session during the transfer between the different communication technologies.

In summary, the network element 102 may offer converged services delivery and mobility across disparate core network 104. In some embodiments, network element 102 may be configured to perform one or more of the following: manage the control layer of a communication session, coordinate the establishment of communication sessions, or initiate the origination of a communication session. The network elements 102 may operate independently of access-side elements. For example, the elements of network element 102 used to communicate with the core networks 104 may be separate and/or independent from the elements of network element 102 used to communicate with the access networks 112. The independent operation of the two ends of communications may decouple terminal technology from access technology and/or access technology from core technology. By decoupling the access and core sides, independent communication sessions may be established to multiple terminating points such as devices 114 that utilized different technologies. The decoupling may also enable localized routing/switching in which only an intra-node connection is made without utilizing bearer traffic resources from the network-side. The network device 114 accessing core networks 104 through different access networks 112 (e.g., RAN 112a, broadband access network 112b) may appear to be compatible devices despite differing protocol technology. Network element 102 may enable inter-connectivity communications translations between diverse core services. Network element 102 may be accessed by any number of different access providers 112, core networks 104, and/or end user devices 114.

As illustrated, core networks 104 include mobile core network 104a, IMS/SIP core network 104b, and PSTN core network 104c. Core networks 104 may include other core networks (e.g., GPRS, IPTV) without departing from the scope of this disclosure to provide services to devices 114. Services provided by core networks 104 may include one or more of the following: Mobile Voice services, Short Message Service (SMS), Multimedia Messaging Services (MMS), Plain Old Telephone Service (POTS), Broadband Internet Access, VoIP service, or others. The system 100 may include some, all, or different core networks without departing from the scope of this disclosure. For example, core networks 104 may include an IPTV core network. The mobile core network 104a can offer services such as Gateway Mobile Switching Center (GMSC) 106 and Mobile Switching Center (MSC) 108. The MSC 108 may provide GSM services, location update, and circuit switching to mobile access users. The GMSC 106 may interface the MSC 108 with the PSTN 104c. The GMSC 106 may also determine the closest MSC 108 to a user for putting a call through to the user. A Home Location Register (HLR) 110 can contain a database of GSM subscribers. The HLR 110 may contain information regarding which services each user has subscribed to. In addition, the HLR 110 may be used to track the billing of each user within the mobile core network 104a.

Another core network 204 within the system 100 is the IP Multimedia System (IMS)/Session Initiation Protocol (SIP) core network 104b is a network that enables mobile communication technology to access IP based services. The IMS standard was introduced by the 3rd generation partnership project (3GPP) which is the European 3rd generation mobile communication standard. In general, the IMS standard discloses a method of receiving an IP based service through a wireless communication terminal such as mobile devices 114. A set of SIP servers 118 may allow subscribers of the IMS/SIP core network 104b to place voice and/or video calls via voice over internet protocol (VoIP) networking. A 3G video gateway 120 may provide third generation cellular technology, incorporating voice and non-voice data elements within the communication protocol. Content traveling through the 3G video gateway 120 can include video, music download, instant messaging, etc. An Authentication Authorization, and Accounting (AAA) database 122 tracks resources consumed by the subscribers of the IMS/SIP core network 104b. A Digital Rights Management (DRM) database 124 monitors the distribution of copyrighted content such as music, movies, etc. The DRM database 124 also enforces usage restrictions of the copyrighted content. Although not illustrated, IMS network 104b may include call session control function (CSCF), home subscriber server (HSS), application server (AS), and other elements. CSCF acts as a proxy and routes SIP messages to IMS network components such as AS. HSS typically functions as a data repository for subscriber profile information, such as type of services allowed for a subscriber. AS provides various services for users of IMS network 104b, such as, for example, video conferencing, in which case AS handles the audio and video synchronization and distribution to mobile devices 114.

The Public Switched Telephone Network (PSTN) core network 104c is used for communicating via telephone land lines. The PSTN core network 104c is a circuit-switched telephone network which may be used for land line voice calls, digital subscriber line (DSL) internet access, and/or dial-up modem internet access. A set of access tandem and end office switches 142 segment the network into sections which are considered to be within a local calling distance. For example, communications relayed through the PSTN core network 104c can be sent from a local user via an end office switch, through a series of access tandem switches, and through the remote end office switch to a remote user. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

Access networks 112 includes a radio access network (RAN) 112a, a broadband access network 112b, an access feeder network 112c, and a LAN/WAN 112d. The system 100 may include some, all, or different access networks without departing from the scope of this disclosure. For example, access networks 112 may include a cable television network. RAN 112a provides a radio interface between mobile device 114a and cellular core network 104a that may provide real-time voice, data, and multimedia services (e.g., a call) to mobile devices 114a. In general, RAN 112a communicates air frames via radio frequency (RF) links. In particular, RAN 112a converts between air frames to physical link based messages for transmission through cellular core network 104a. RAN 112a may implement, for example, one of the following wireless interface standards during transmissions: IS-54 (TDMA), Advanced Mobile Phone Service (AMPS), GSM standards, CDMA, Time Division Multiple Access (TDMA), General Packet Radio Service (GPRS), ENHANCED DATA rates for Global EVOLUTION (EDGE), or proprietary radio interfaces.

RAN 112a may include Base Stations (BS) connected to Base Station Controllers (BSC). BS receives and transmits air frames within a geographic region of RAN 112a called a cell and communicates with mobile devices 114a in the cell. Each BSC is associated with one or more BS and controls the associated BS. For example, BSC may provide functions such as handover, cell configuration data, control of RF power levels or any other suitable functions for managing radio resource and routing signals to and from BS. MSC 108 handles access to BSC and network element 102, which may appear as a BSC to MSC 108. MSC 108 may be connected to BSC through a standard interface such as the A-interface.

Access feeder network 112c may provide devices 114 access to core networks 104 via network element 102. In addition, access feeder network 112c may include a Wide Area Network/Metro Area Network (WAN/MAN), cable television network, wireless microwave broadband access (WiMAX), fiber optic cable access network (FTTC/H Ethernet), wireless personal access networks (WiFi/Bluetooth), digital mobile telephony access networks (GSM over IP, UMTS over IP), and/or any other suitable internet/intranet access provider. Alternatively or in combination, access feeder network 112c may include broadband access network 112b. In general, network 106b communicates IP packets to transfer voice, video, data, and other suitable information between network addresses. In the case of multimedia sessions, network 106b may use Voice over IP (VoIP) protocols to set up, route, and tear down calls. In some embodiments, broadband access network 112b may include SIP proxy servers for routing SIP messages. Each SIP proxy server can be any software, hardware, and/or firmware operable to route SIP messages to other SIP proxies, gateways, SIP phones, network element 102, and others. In some embodiments broadband access network 112b may comprises a third generation IP multimedia subsystem for cellular technology (3G/IMS packet network).

A privately-run corporate LAN/WAN 112d, such as a Server Message Block (SMB)/Enterprise network, can additionally connect to the access feeder network 112c via a gateway server 132. In some embodiments, a communication node 134 running on the gateway server 132 can provide translation between the public access feeder network 112c and the corporate LAN/WAN 112d. For example, the communication node 134 may translate between disparate protocols (e.g., WiFi/Bluetooth, GSM over IP, or WiMAX). In another example, the communication node 134 translates between proprietary protocols/methods and open protocols/methods. A set of network servers 138a-c may provide wireless and/or wired access to the LAN/WAN 112d. Any number of devices 114 may be connected to any number of servers 138 within the LAN/WAN 112d.

As illustrated, the devices 114 are segregated into groupings based on common location of usage. The devices 114 are grouped into a set of on-the-road devices 114a, a set of on-break devices 114b, a set of at-home devices 114c, and a set of at-work devices 114d. The system 100 may include some, all, or different end user devices without departing from the scope of this disclosure. In addition, the devices 114 may switch between different access networks 112 without departing from the scope of this disclosure. The set of on-the-road devices 114a illustrates a variety of portable devices which may be used to access core networks 104 through RAN 112a. The on-the-road devices 114a can include, but aren't limited to, a cellular phone, a GPS handset and a satellite phone. The set of on-break devices 114b illustrates a variety of limited mobility devices which can be used to access core networks 104 through access feeder network 112. The on-break devices 114b may be physically connected to the access feeder network 112c or broadband access network 112b such as through an Ethernet cable, a WiFi/Bluetooth link, or any other suitable wireless and/or wireline link. The on-break devices 114b can include, but aren't limited to, a personal digital assistant (PDA) or laptop computer.

The set of at-home devices 114c illustrate a variety of devices which can be used to access the core networks 104 via the access feeder network 112c, the broadband access network 112b, and/or the radio access network 112a. The at-home devices 114c may have limited or no mobility, potentially requiring dedicated lines for their use. For example, a telephone 144a may connected via land line to the PSTN core network 104c. Alternatively, the telephone 144a may be connected via home computer such as the laptop 144b to the IMS/SIP core network 104b to enable IP telephony. The laptap 144b, similarly, may be connected to the PSTN core network 104c via a dial-up modem or broadband DSL service. In another embodiment, the laptop 114b may be connected via a cable modem or Ethernet to the IMS/SIP core network 104b. A television 144c may be connected to IPTV service within the IMS/SIP core network 104b via a set-top box. The at-home devices 114c may also include a cellular phone 144d communicating with the mobile core network 104a. Any number of devices, including but not limited to GPS, cellular, IP, and other technology, may be included within the at-home devices 114c.

Similarly, a set of at-work devices 114d allows users access to the core networks 104 through the corporate LAN/WAN 112d environment. The at-work devices 114d may include, but are not limited to, intranet/internet access via personal computers such as a laptop computer, SIP telephones, cellular phones, and IP teleconferencing service through a television set.

In some embodiments, a personal communication device 148 may have built-in converged service offerings and/or communication methods. The personal communication device 148 can be any device capable of communicating information from a core network, including but not limited to a cellular phone, data phone, pager, personal computer, smart phone, PDA, etc. In one example, the multi-protocol convergence engine technology could be embedded within a PDA 148. In this circumstance, the PDA 148 would have built-in capability of accessing services from a number of core networks 104. In some embodiments, the device 148 could be capable of simultaneously communicating via the PSTN core network 140a and the IMS/SIP core network 104b, for example to provide concurrent voice services along with music downloads.

In one aspect of operation, a user may be at work initiating a Skype session on a laptop device 114d connected to the corporate LAN 112d to contact a colleague who is on an international business trip and is only accessible via a satellite phone 114a. The network element 102 recognizes the destination address of the Skype session as requiring translation between core networks 104 and facilitates the translation of the Skype client technology based on the IMS/SIP core network 104b to the satellite access network technology based in the mobile core network 104a to enable the call. In the opposite direction, the network element 102 facilitates the translation from the mobile core network 104a back to the IMS/SIP core network 104b to relay the colleague's response back to the home office.

In another aspect of operation, a user may be at home watching a baseball game on the television 144c which is connected to IPTV service provided by the cable television network 112c within the IMS/SIP core network 104b via a set-top box. If the user needs to pick up a child from soccer practice in the middle of the baseball game, the user may choose to migrate the IPTV session from the television 144c to an on-the-road device 114a such as a cellular phone with multimedia capability. The network element 102 may enables transition of the IPTV session currently transmitting to the television 144c to the user's cellular phone 114a, for example by converting the session stream from the IPTV communication technology to the GSM communication technology and routing the session to the user's cellular phone 114a, so that the user may continue to follow the baseball game while in transit.

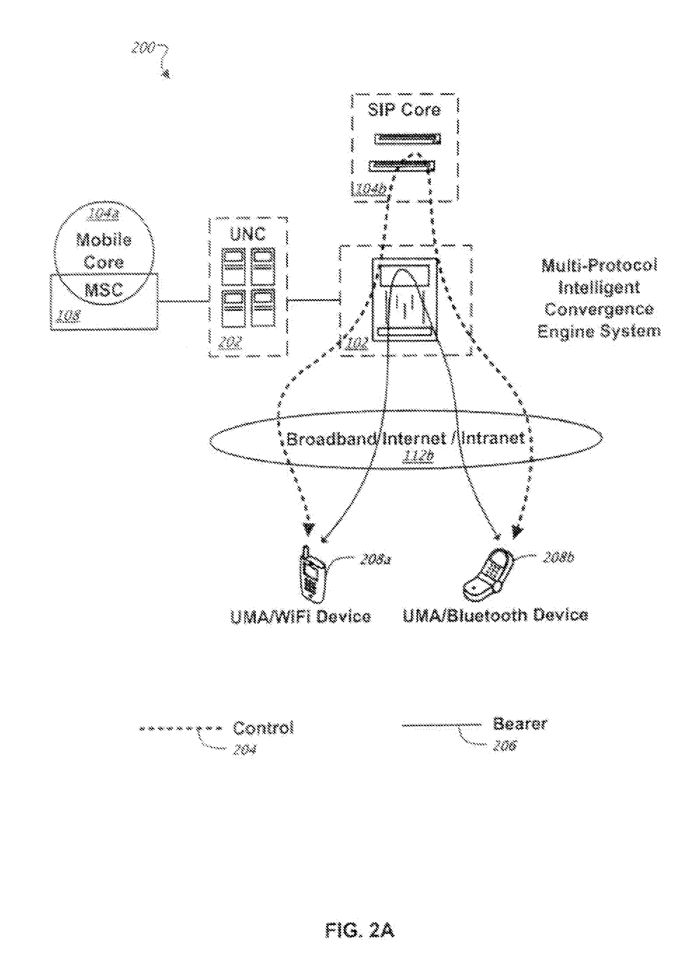

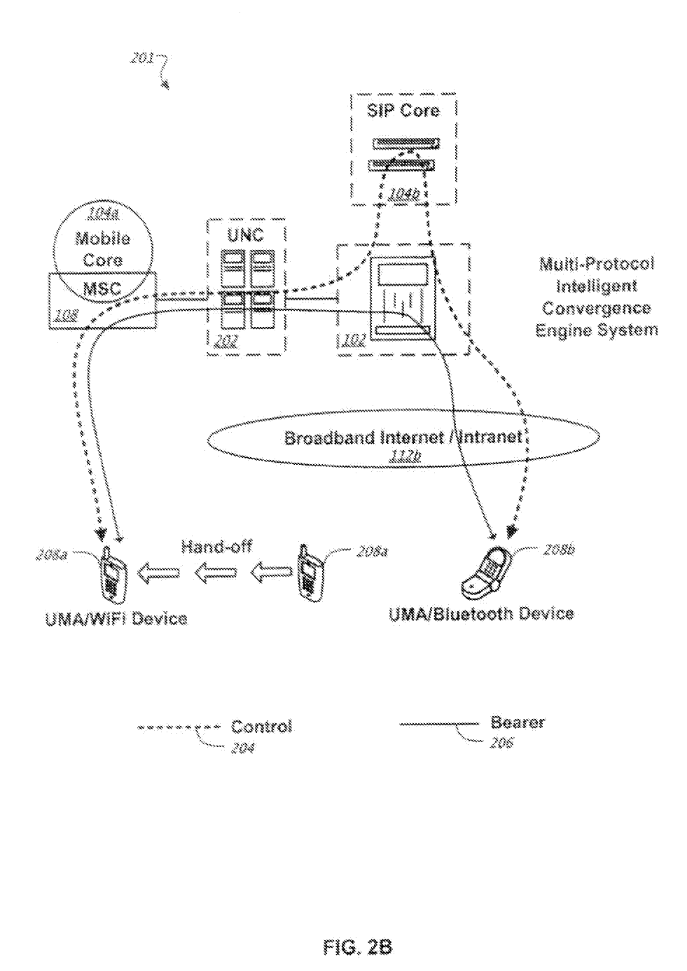

FIG. 2A is a diagram 200 illustrating an example signal path between two UMA devices 208 in accordance with one embodiment of the present disclosure. For ease of reference, only some of the elements of communication system 100 of FIG. 1 are shown. UMA allows roaming and handover between local area networks and wide area networks through a dual-mode mobile device. The local network provider may be based on a private wireless technology such as Bluetooth or WiFi which provide access to the SIP core network 104b, while the wide network provider may be GSM or UMTS, for example, which correlate their services with the mobile core network 104a. Dual-mode UMA devices 208 may switch between local network and wide network operating modes depending upon current use. In the illustrated embodiment, two signal streams are shown between UMA/WiFi device 208a and UMA/Bluetooth device 208b; a control signal 204 and a bearer signal 206. UMA/WiFi device 208a and UMA/Bluetooth device 208b are connected to the communications system 100 through the broadband internet/intranet access network 112b.

A UMA Network Controller (UNC) 202 connects the mobile core network 104a to the network element 102. The UNC 202 may authenticate and authorize access to GSM voice and GPRS data services within the mobile core network 104a for UMA devices which otherwise may communicate locally with SIP core network 104b. UNC 202 can include any software, hardware, and/or firmware operable to manage UMA devices. For example, UNC 202 may perform registration for UMA control services, set up or tear down bearer paths, terminate secure remote access tunnels from enterprise devices, and other suitable services. In addition, UNC 202 appears as a base station subsystem to mobile core network 104a and thus, may provide location information for the UMA devices 208. For example, UNC 202 may store the identity, location, and/or capabilities of the UMA devices 208 during registration. UNC 202 may require such information to provide support services and/or potentially handover functionality for UMA devices 208 when interconnecting with the mobile core network 104a.

Due to the difference in communication protocol between WiFi and Bluetooth, the UMA devices 208 may use the mobile core network 104a and GSM to engage in a voice session. Rather than depending upon the services of UNC 202 to allow UMA/WiFi device 208a to communicate with UMA/Bluetooth device 208b, the network element 102 may provide more localized access by translating and locally switching to WiFi and Bluetooth communication protocols between devices 208. The network element 102 may enable a service to be delivered to an end user independent of the user's terminal device type and independent of the access/core network from which the user is being serviced. The network element 102 can accomplish this by coordinating the establishment of network sessions or voice calls. For example, the network element 102 may initiate the origination of a bi-directional voice/video call or chat session or a uni-directional streaming media or IPTV communication. The network element 102 may also manage the control layer of network protocol communications.

In one aspect of operation, UMA/WiFi device 208a wirelessly transmits a request through the broadband internet/intranet access network 112b to network element 102 to initiate a call with UMA/Bluetooth device 208b. In some embodiments, network element 102 receives a WiFi control message 204 and switches it to SIP core 104b. The network device 102 intercepts the control response 204, generates a Bluetooth control response 204 based, at least in part, on the WiFi control response, and routes it to the UMA/Bluetooth device 208b through the broadband internet/intranet access network 112b. Control traffic 204 may enable the SIP core network 104b to authenticate and authorize subscribers for services, implement call-routing policies, and provide features to subscribers.

However, SIP is a peer-to-peer communication method, which means that the voice session itself does not require interaction with the SIP core network 104b. In this case, the bearer signal 206 is capable of being routed between the devices 208 through the network element 102 via the broadband internet/intranet access network 112b independent of the SIP core network 104b. The network element 102 may translate between protocol parameters and/or digits to enable communication between the two devices 208.

In one aspect of operation, network element 102 may intercept a WiFi voice transmission destined for UMA/Bluetooth device 208b, convert, translate, or otherwise modify the WiFi message to a form readable by UMA/Bluetooth device 208b, and then route the modified WiFi message to UMA/Bluetooth device 208b. Similarly, an incoming voice message from the UMA/WiFi device 208a may be captured and converted, translated, or otherwise modified to enable recognition by UMA/Bluetooth device 208b. The network element 102 may track the destination address of each device 208 in order to provide local switching of the messages independent of UNC 202.

FIG. 2B is a diagram 201 illustrating an example signal path between two UMA devices 208 in accordance with another embodiment of the present disclosure. The network element 102, having the capability of independently controlling both the incoming and the outgoing segments of the communication signals 204 and 206, may also be able to handover a service being delivered to one device 208 to another device 208 based on a different communication technology. Similarly, network element 102 may be able to handover services for a device 208, such that a device functioning under a first service (e.g., access network or core network mode, etc) can seamlessly transition into functioning under a second service.

In one aspect of operation, UMA/WiFi device 208a wirelessly transmits a request to initiate a call with UMA/Bluetooth device 208b. If, once the communications signals 204 and 206 have been established as in diagram 200 of FIG. 2A, the subscriber of the UMA/WiFi device 208a leaves the reach of the local broadband internet/intranet 112b access area, for instance by driving away in a taxi, the network element 102 may activate a session hand-off so that the nearest MSC 108 of the mobile core network 104a may track and provide services to the UMA/WiFi device 208a to continue the voice session. In accomplishing a device hand-off, the UMA/Bluetooth device 208b outgoing control signal 204 and bearer signal 206, after the control signal 204 has been bounced through the SIP core network 104b, are now routed from the network element 102 through the UNC 202 to the MSC 108 and potentially the mobile core network 104a before reaching the UMA/WiFi device 208a. Similarly, communications signals 204 and 206, originating from the UMA/WiFi device 208a, may be routed to the MSC 108 and mobile core network 104a, over the UNC 202, before reaching the network element 102 and onwards towards the destination of the UMA/Bluetooth device 208b. This allows the UMA/WiFi device 208a communication to achieve authorization, authentication, and subscriber services from the mobile core network 104a while allowing the UMA/Bluetooth device 208b to continue to utilize the local broadband internet/intranet access network 112b and SIP core network 104b services. The network element 102, in this circumstance, provides conversion between GSM communications protocol being used by the UMA/Wifi device 208a and Bluetooth communications protocol being used by the UMA/Bluetooth device 208b.

In another aspect of operation, UMA/WiFi device 208a wirelessly transmits a request to initiate a call with UMA/Bluetooth device 208b. If, once the communications signals 204 and 206 have been established as in diagram 200 of FIG. 2A, the subscriber of the UMA/WiFi device 208a receives a second call from a device not pictured within diagram 201, and the subscriber opts to conference the new call into the ongoing voice session with UMA/Bluetooth device 208b using Explicit Call Transfer (ECT), the network element 102 may activate a session hand-off so that the services available through the MSC 108 of the mobile core network 104a, e.g. ECT, are available to the UMA/WiFi device 208a to complete the conference call.

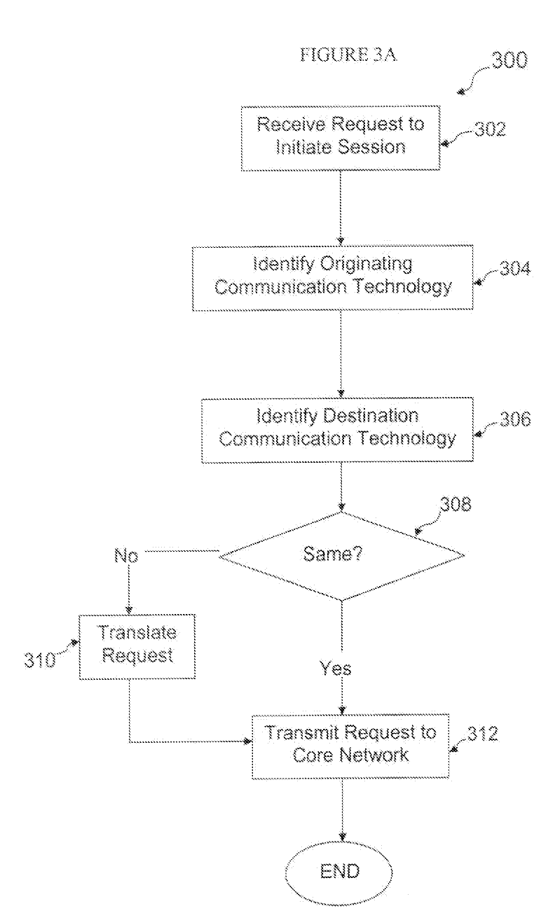

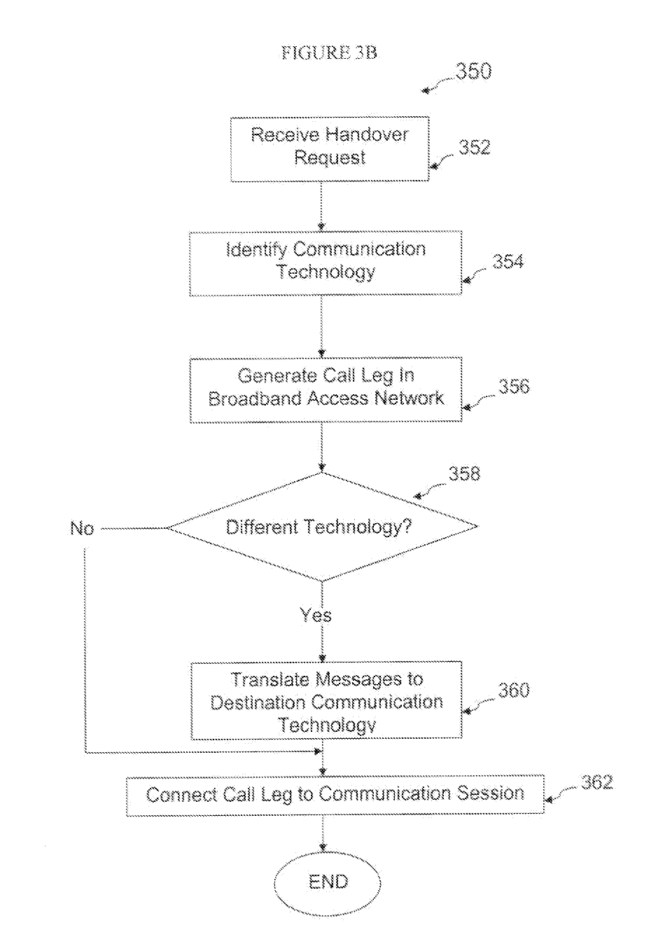

FIGS. 3A to 3B are flow diagrams illustrating example methods for managing communication sessions using different communication technologies. The illustrated methods are described with respect to system 100 of FIG. 1, but these methods could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Referring to FIG. 3A, method 300 begins at decisional step 302 where network element 102 receives a request from a device 114 to initiate a communication session with a core network 104. For example, network element 102 may receive the initiation request from a UMA device 114 to receive streaming video from IMS network 104b. At step 302, network element 102 identifies the originating communication technology. In the example, network element 102 identifies that device 114 is a UMA device requesting services through broadband access network 112b. Network element 102 identifies the terminating communication technology at step 306. Returning to the example, network element 102 identifies that UMA device 114 is requesting services from an RSTP server in IMS network 104b. If network element determines that the originating and terminating communication technologies are the same at decisional step 308, then execution proceeds to step 312. If network element determines that the originating and terminating communication technologies are different at decisional step 308, then network element 102 translates the initiation request from the originating communication technology to the second communication technology at step 310. Again returning to the example, network element 102 translates the UMA request to an RSTP request. Next, at step 312, network element 102 transmits the initiation request to the appropriate core network 104.

Referring to FIG. 3B, method 350 begins at step 352 where network element 102 receives a request to handover an existing communication session to a different client device 114. For example, network element 102 may receive a request to transfer a call session from a UMA device 114 to a SIP device 114. At step 354, network element 102 identifies the communication technology of the new device 114. In the example, network element determines that the new device 114 is a SIP-based device requesting to establish service through broadband access network 112b. Network element 102 generates a call leg with the SIP device 114 through broadband access network 112b at step 356. If the communication session provided by the core network 104 is based on a different communication technology that the new device 114, then, at step 360, network element 102 translates messages between the two different communication technologies. At step 362, network element connect the call leg to the communication session to receive services from the core network 104. Network element 102 may establish ½ call legs associated with different communication technologies and connect these portions to form a single logical stream enabling sing directional or bi-directional transfer of information.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
receiving a message from a first network device, the received message compatible with a first communication technology;
identifying a destination communication technology from a plurality of communication technologies based, at least in part, on the received message;
automatically converting the received message to a message compatible with the destination communication technology, the first communication technology different from the destination communication technology; and
transmitting the converted message to a second network device comprising the first of the plurality of communication technologies.

2. The method of claim 1, the received message encoded in a first protocol, the converted message encoded in a second protocol.

3. The method of claim 2, the first protocol different from the second protocol.

4. The method of claim 1, the plurality of communication technologies comprises a second plurality of communication technologies, the method further comprising identifying the first communication technology from a first plurality of communication technologies.

5. The method of claim 4, the first plurality of communication technologies different from the second plurality of communication technologies.

6. The method of claim 1, wherein transmitting the converted message to the second network device comprises transmitting the converted message to the second network device independent of the first network device.

7. The method of claim 1, the received message associated with a connection-oriented session, the converted message associated with a connectionless-oriented session.

8. The method of claim 1, wherein the plurality of communication technologies comprises at least one of peer to peer, GSM, UMTS, SIP, UMA, RTSP, IGMP, or ISUP.

9. A method, comprising:
identifying a device operable to receive services from a first core network through a first access network, the first core network and the first access network comprising a first communication technology; and
providing services from a second core network to the device through the first access network, the second core network comprising a second communication technology different from the first communication technology.

10. The method of claim 9, wherein providing services from a second core network to the device through the first access network comprises translating services based on a second communication technology to services based on the first communication technology, the first communication technology different from the second communication technology.

11. A method comprising:
receiving a request to handover a communication session from a first device based on a first communication technology to a second device based on a second communication technology, the first communication technology different than the second communication technology; and
providing the communication session to the second device in a form compatible with the second communication technology.

12. The method of claim 11, wherein providing the communication session to the second device comprises translating the communication session to a form compatible with the second communication technology.

13. A method for providing services for a communication session, comprising:
receiving services of a first communication technology in a first protocol; and
internetworking the first communication technology with a second communication technology of an end user device.

14. The method of claim 13, further comprising internetworking the first protocol with a second protocol used by the end user device.

15. A communication network, comprising:
a technology aware node coupled to a plurality of core networks of different communication technologies; and
the technology aware node configured to provide services from each of the core network to end user devices of a plurality of communication technologies.

16. A method of providing services in a communication session, comprising:
providing services from a network of a first communication technology over a communication session to an end user device; and
providing services from a second network of a second communication technology over the communication session to the end user device.

17. The method of claim 16, the end user device comprising a mobile device.

18. The method of claim 16, the end user device using communication technology different from the first communication technology and the second communication technology.

19. The method of claim 16, the first communication technology is one of one of peer to peer, GSM, UMTS, SIP, UMA, RTSP, IGMP, or ISUP.

20. The method of claim 16, the second communication technology is one of one of peer to peer, GSM, UMTS, SIP, UMA, RTSP, IGMP, or ISUP.

21. A method for providing services in a communication network, comprising:
providing services over a communication session from a network of a first communication technology to a first end user device; and
handing over the call session to a second end user device, the second end user device using a communication technology different from that of the first end user device.

22. The method of claim 21, the communication technology of the first and second end user devices different from the communication technology of the network.

23. The method of claim 21, the communication technology of the first end user device is one of peer to peer, GSM, UMTS, SIP, UMA, RTSP, IGMP, or ISUP.

24. The method of claim 21, the communication technology of the second end user device is one of peer to peer, GSM, UMTS, SIP, UMA, RTSP, IGMP, or ISUP.

25. The method of claim 21, the first end user device comprising a mobile device.

26. The method of claim 21, both the first and second end user devices comprising first and second mobile devices.

27. A system for a communication network, comprising:
one or more interfaces configured to communicate with a plurality of core networks of different communication technologies and a plurality of access networks of different communication types; and
a convergence engine coupled to one or more interfaces and configured to receive from one of the core networks information in a first communication technology for a call session and to convert the information to a second communication technology of the access networks over which an end user device of the call session is coupled to the convergence engine.

28. The system of claim 27, the convergence engine further configured to convert between different communication protocols.

29. The system of claim 27, the system integrated into a single network node.

30. The system of claim 27, the first communication technology is one of one of peer to peer, GSM, UMTS, SIP, UMA, RTSP, IGMP, or ISUP.

31. The system of claim 27, the second communication technology is one of one of peer to peer, GSM, UMTS, SIP, UMA, RTSP, IGMP, or ISUP.

32. The system of claim 27, the system integrated into a single network node, the convergence engine including a client side configured to translated between different protocols and a server side configured to translated between different protocols and having a half call model switch.

33. A method, comprising:
receiving a request to handover a communication session from a first device coupled to an access network to a second device couple to the access network, the first device and the second device comprise a same communication technology; and
providing the communication session to the second device independent of a core network associated with the communication technology.
